(19) United States
(12) Patent Application Publication
(10) Pub. No.: US 2008/0154478 A1
(43) Pub. Date: Jun. 26, 2008

(54) SYSTEM AND METHOD FOR INDICATING QUALITY OF MOTOR OIL IN A VEHICLE WHOSE ENGINE HAS AN EXHAUST AFTERTREATMENT DEVICE THAT REQUIRES OCCASIONAL REGENERATION

(75) Inventor: Timothy M. Lyons, Batavia, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/613,795

(22) Filed: Dec. 20, 2006

(51) Int. Cl. F02D 45/00; G06F 19/00

(52) U.S. Cl. 701/102; 60/295; 702/81

(57) ABSTRACT

A system and method for including the effect of regeneration of a diesel particulate filter (22) on quality of engine motor oil.

### FIELD OF THE INVENTION

This invention relates generally to motor vehicles, such as trucks, that are powered by internal combustion engines, particularly diesel engines that have certain exhaust gas treatment devices for treating exhaust gases passing through their exhaust systems. The invention especially relates to a system and method for including the effect of regenerating an aftertreatment device on quality of motor oil in the engine.

### BACKGROUND OF THE INVENTION

Known systems and methods for indicating when the motor oil that lubricates moving internal parts of an engine needs to be changed are commonly based on elapse of time and/or miles traveled after the immediately previous oil change. The lengths of time and/or of mileage may be based on data developed through prior studies of the effect of vehicle operation on motor oil lubricating quality.

Commonly owned U.S. Pat. No. 6,513,367 mentions other known systems and methods. One involves using a dielectric sensor to monitor the quality of motor oil. Another involves estimating oil quality by tracking vehicle operation after the most recent addition of fresh motor oil. That patent also identifies various factors that contribute to contamination of engine motor oil.

One of those factors is soot created by combustion of fuel in the engine. The patent describes a sophisticated algorithm for estimating the amount of soot added to the motor oil by each combustion event in each cylinder. Specifically, soot addition is estimated as a function of fuel flow, load, coolant temperature, and an injection timing factor. When the quality of the oil has deteriorated to some defined extent suggesting that the oil be changed, a signal to that effect is given.

Certain engines, diesel engines especially, may have one or more aftertreatment devices in their exhaust systems for removing undesired materials from engine exhaust so that those materials don't enter the atmosphere. Such devices may at times require regeneration. As used here, “regeneration” of an aftertreatment device applies here to any aftertreatment device that on occasion requires a specific cylinder combustion event that creates additional soot, HC, and the like in order to maintain effectiveness of the aftertreatment device.

One such device is a diesel particulate filter (DPF) that traps certain particulates in the exhaust. A DPF requires regeneration from time to time in order to maintain particulate trapping efficiency. Regeneration as applied to a DPF involves the presence of conditions that will burn off trapped particulates whose unchecked accumulation would otherwise impair DPF effectiveness. While “regeneration” of a DPF often refers to the general process of burning off DPM from a DPF, two particular types of DPF regeneration are recognized by those familiar with DPF regeneration technology as presently being applied to motor vehicle engines.

“Passive regeneration” is generally understood to mean regeneration that can occur anytime that the engine is operating under conditions that burn off DPM without having been initiated by a specific regeneration strategy embodied by algorithms in an engine control system. “Active regeneration” is generally understood to mean regeneration that is initiated intentionally, either by the engine control system on its own initiative, or by the driver causing the engine control system to initiate a regeneration, with the goal of elevating temperature of exhaust gases entering the DPF to a range suitable for initiating and maintaining burning of trapped particulates.

Active regeneration may be initiated before a DPF becomes loaded with DPM to an extent where regeneration would be mandated by the engine control system on its own due to the amount of DPM loading.

The creation of conditions for initiating and continuing active regeneration, whether forced by the control system on its on or by driver action, generally involves elevating the temperature of exhaust gas entering the DPF to a suitably high temperature to initiate and continue buring of trapped particulates. Because a diesel engine typically runs relatively cool and lean, the post-injection of diesel fuel is one technique used as part of a regeneration strategy to elevate exhaust gas temperatures entering the DPF while still leaving excess oxygen for burning the trapped particulate matter. Post-injection may be used in conjunction with other procedures and/or devices, a diesel oxidation catalyst ahead of the DPF for example, for elevating exhaust gas temperature to the relatively high temperatures needed for active DPF regeneration.

The post-injection of fuel for DPF regeneration however inherently creates certain additional exhaust constituants, including an excess of unburned fuel, to be exhausted from each combustion chamber. Hence, active regeneration of a DPF, even if only occasional, creates an additional contamination component.

### SUMMARY OF THE INVENTION

The present invention is directed toward a strategy that specifically takes active regeneration of a DPF into account when calculating quality of engine motor oil.

One general aspect of the invention relates to a method for estimating lubricating quality of motor oil in an internal combustion engine that propels a vehicle and has an exhaust system containing an aftertreatment device that is occasionally regenerated.

In a data processing system associated with the engine, various data are processed to develop a data estimate of the lubricating quality of motor oil currently in the engine. The data includes data to identify occurrence of an active regeneration event and data that is indicative of an amount of degradation in lubricating quality of motor oil in the engine due to the identified occurrence of the forced regeneration event. A data estimate of the amount of degradation in lubricating quality of motor oil in the engine due to the forced regeneration event is developed, and then processed to in calculating the data estimate of the quality of motor oil currently in the engine.

Another generic aspect relates to a method for estimating degradation in lubricating quality of motor oil in an internal combustion engine that propels a motor vehicle due to occasional forced regeneration of an aftertreatment device in an exhaust system of the engine.

In a data processing system associated with the engine, the following data is processed: data that identifies each occurrence of an active regeneration event that has occurred over a span of time during which the vehicle has been in use without any fresh motor oil being introduced into the engine; and data that is indicative of degradation in lubricating quality of motor oil in the engine due to each identified occurrence of an active regeneration event. The processing yields a data estimate of the amount of degradation due to each event. The individual data estimates are accumulated and used in calculating a data estimate of the amount of degradation that has occurred over the span of time during which the vehicle has been in use without any fresh motor oil being introduced into the engine.

A further generic aspect relates to a motor vehicle comprising an internal combustion engine for propelling the vehicle, a lubrication system for circulating motor oil to lubricate moving internal parts of the engine, an exhaust system through which exhaust passes from combustion chambers of the engine into surrounding atmosphere, an aftertreatment device for treating exhaust passing through the exhaust system before the exhaust enters the atmosphere, and an engine control system for processing various data to control various aspects of engine operation.

The control system a) occasionally forces regeneration of the aftertreatment device to remove at least some material whose unchecked accumulation in the device would otherwise impair effectiveness of the device, and b) develops a data estimate of the lubricating quality of motor oil currently in the engine, including processing data to identify occurrence of an active regeneration event, processing data that is indicative of an amount of degradation in lubricating quality of motor oil in the engine due to the identified occurrence of the forced regeneration event to develop a data estimate of the amount of degradation in lubricating quality of motor oil in the engine due to the identified occurrence, and processing the data estimate of the amount of degradation in lubricating quality of motor oil in the engine due to the identified occurrence to develop the data estimate of the quality of motor oil currently in the engine.

According to a still further aspect, the control system a) occasionally causes forced regeneration of the aftertreatment device to remove at least some material whose unchecked accumulation in the device would impair effectiveness of the device, and b) processes data that identifies each occurrence of an active regeneration event that has occurred over a span of time during which the vehicle has been in use without any fresh motor oil being introduced into the engine, processes data that is indicative of degradation in lubricating quality of motor oil in the engine due to each identified occurrence of an active regeneration event to develop a data estimate of the amount of degradation due to each identified occurrence of an active regeneration event, and accumulates the individual data estimates to develop a data estimate of the amount of degradation that has occurred over the span of time during which the vehicle has been in use without any fresh motor oil being introduced into the engine.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is an illustration of a representative motor vehicle having a diesel engine with an exhaust after-treatment device that requires occasional regeneration.

FIG. 2 is a diagram showing steps of a representative embodiment of the present invention as implemented in a control system of the vehicle of FIG. 1.

### DESCRIPTION OF THE PREFERRED EMBODIMENT

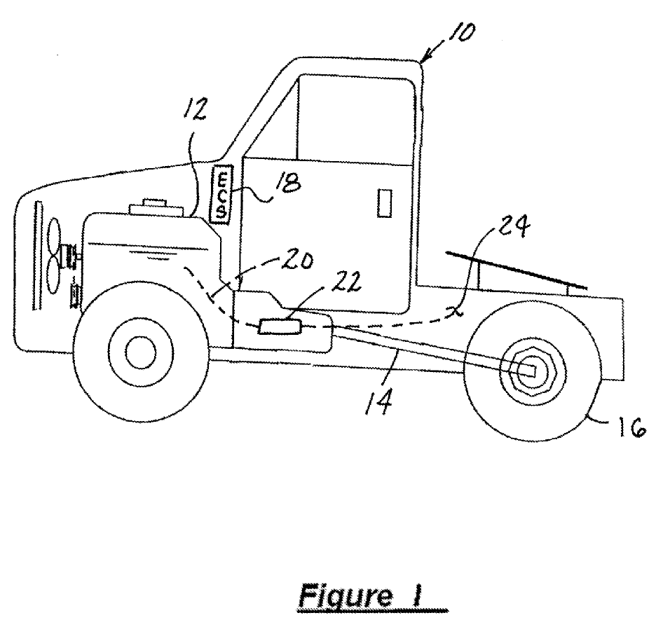

FIG. 1 shows a truck 10 having a diesel engine 12 and a drivetrain 14 that couples the engine to driven wheels 16 for propelling the truck. Engine 12 has a processor-based engine control system (ECS) 18 that processes data from various sources to develop various control data for controlling various aspects of engine operation.

Engine 12 also has an exhaust system 20 for conveying exhaust gases generated by combustion of fuel in cylinders of engine 12 from the engine to the surrounding atmosphere. Exhaust system 20 contains one or more after-treatment devices, one of which is a diesel particulate filter (DPF) 22, for treating exhaust gases before they pass into the atmosphere via a tailpipe 24.

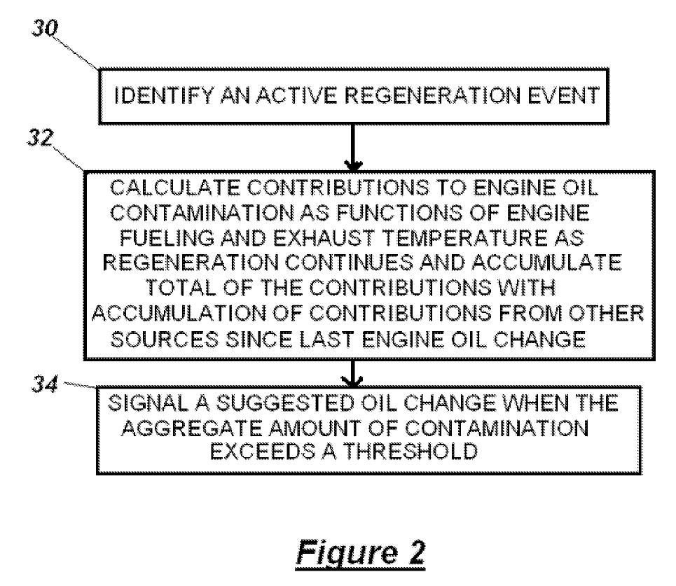

Internally, engine 12 has a lubrication system for lubricating moving parts. The diagram of FIG. 2 illustrates steps that are embodied in an algorithm in ECS 18 that frequently calculates the quality of motor oil used in the engine lubricating system. Various data are processed to calculate a data estimate of the quality of motor oil currently in engine 12.

In accordance with principles of the invention, certain additional data are processed when an active regeneration occurs. First the occurrence of an active regeneration event is identified in any suitably appropriate way. (Step 30 in FIG. 2). Data values representing contamination that being contributed to the oil as the regeneration proceeds are accumulated. The data values are related to certain parameters such as engine fueling and exhaust temperature. A map may be populated with data values for contaminant contribution based on engine fueling and exhaust temperature. Engine fueling and exhaust temperature are used to select a corresponding contaminant contribution from the map, or the contaminant contribution may be calculated using a suitable formula.

Because the regeneration time may vary from regeneration to regeneration, data values for contamination contribution may be selected, or calculated, at selected times during a regeneration and accumulated. The accumulation is added to a total calculation for all other contamination contributions. (Step 32 in FIG. 2.) The aggregate amount of contaminant serves to indicate oil quality. When quality drops below a certain threshold, ECS 20 issues a signal to suggest changing the oil. (Step 34 in FIG. 2.)

While a presently preferred embodiment of the invention has been illustrated and described, it should be appreciated that principles of the invention apply to all embodiments falling within the scope of the invention defined by the following claims.

What is claimed is:

1. A method for estimating lubricating quality of motor oil in an internal combustion engine that propels a vehicle and has an exhaust system containing an aftertreatment device that is occasionally regenerated, the method comprising:
in a data processing system associated with the engine, processing various data to develop a data estimate of the lubricating quality of motor oil currently in the engine, including processing data to identify occurrence of an active regeneration event, processing data that is indicative of an amount of degradation in lubricating quality of motor oil in the engine due to the identified occurrence of the forced regeneration event to develop a data estimate of the amount of degradation in lubricating quality of motor oil in the engine due to the event, and processing the data estimate of the amount of degradation in lubricating quality of motor oil in the engine due to the identified occurrence in a calculation of the data estimate of the quality of motor oil currently in the engine.

2. A method as set forth in claim 1 wherein the step of processing data that is indicative of an amount of degradation in lubricating quality of motor oil in the engine due to the identified occurrence of the forced regeneration event comprises processing data related to fueling of the engine.

3. A method as set forth in claim 1 wherein the step of processing data that is indicative of an amount of degradation in lubricating quality of motor oil in the engine due to the identified occurrence of the forced regeneration event comprises processing data related to exhaust temperature.

4. A method as set forth in claim 1 wherein the step of processing the data estimate of the amount of degradation in lubricating quality of motor oil in the engine due to the identified occurrence of the forced event in a calculation of the data estimate of the quality of motor oil currently in the engine comprises adding the data estimate of the amount of degradation in lubricating quality of motor oil in the engine due to the identified occurrence of the forced regeneration event to a cumulative total of prior data estimates of the amount of degradation in the lubricating quality of motor oil in the engine due to prior identified occurrences of forced regeneration events.

5. A method for estimating degradation in lubricating quality of motor oil in an internal combustion engine that propels a motor vehicle due to occasional forced regeneration of an aftertreatment device in an exhaust system of the engine, the method comprising:
in a data processing system associated with the engine, processing data that identifies each occurrence of an active regeneration event that has occurred over a span of time during which the vehicle has been in use without any fresh motor oil being introduced into the engine, processing data that is indicative of degradation in lubricating quality of motor oil in the engine due to each identified occurrence of an active regeneration event to develop a data estimate of the amount of degradation due to each event, and accumulating the individual data estimates in a calculation of a data estimate of the amount of degradation that has occurred over the span of time during which the vehicle has been in use without any fresh motor oil being introduced into the engine.

6. A method as set forth in claim 5 including processing the data estimate of the amount of degradation that has occurred over the span of time during which the vehicle has been in use without any fresh motor oil being introduced into the engine and a data value for a defined amount of degradation, and causing issuance of a distinctive signal when the processing of the data estimate of the amount of degradation that has occurred over the span of time during which the vehicle has been in use without any fresh motor oil being introduced into the engine values and of the data value for a defined amount of degradation discloses that the amount of degradation that has occurred over the span of time during which the vehicle has been in use without any fresh motor oil being introduced into the engine exceeds the defined amount of degradation.

7. A motor vehicle comprising:
an internal combustion engine for propelling the vehicle;
a lubrication system for circulating motor oil to lubricate moving internal parts of the engine
an exhaust system through which exhaust passes from combustion chambers of the engine into surrounding atmosphere;
an aftertreatment device for treating exhaust passing through the exhaust system before the exhaust enters the atmosphere;
an engine control system for processing various data to control various aspects of engine operation including
a) occasionally forcing regeneration of the aftertreatment device to remove at least some material whose unchecked accumulation in the device would otherwise impair effectiveness of the device, and
b) developing a data estimate of the lubricating quality of motor oil currently in the engine, including processing data to identify occurrence of an active regeneration event, processing data that is indicative of an amount of degradation in lubricating quality of motor oil in the engine due to the identified occurrence of the forced regeneration event to develop a data estimate of the amount of degradation in lubricating quality of motor oil in the engine due to the identified occurrence, and processing the data estimate of the amount of degradation in lubricating quality of motor oil in the engine due to the identified occurrence to develop the data estimate of the quality of motor oil currently in the engine.

8. A motor vehicle as set forth in claim 7 wherein the aftertreatment device comprises a diesel particulate filter that in the absence of a regeneration event traps particulates that are burned off during a subsequent regeneration event.

9. A motor vehicle as set forth in claim 7 wherein the control system comprises an algorithm for selecting one of different modes of forced regeneration based on operating condition of the vehicle.

10. A motor vehicle as set forth in claim 7 wherein the control system comprises an algorithm for processing data related to fueling of the engine during an identified occurrence of an active regeneration event to estimate degradation in lubricating quality of motor oil in the engine due to the identified occurrence of the event.

11. A motor vehicle as set forth in claim 7 wherein the control system comprises an algorithm for processing data related to exhaust temperature an identified occurrence of an active regeneration event to estimate degradation in lubricating quality of motor oil in the engine due to the identified occurrence of the event.

12. A motor vehicle as set forth in claim 7 wherein the control system comprises an algorithm for adding the estimated amount of degradation in lubricating quality developed during each identified occurrence of an active regeneration event to a cumulative total of prior data estimates of the amount of degradation in the lubricating quality of motor oil due to prior identified occurrences of forced regeneration events.

13. A motor vehicle comprising:
an internal combustion engine for propelling the vehicle;
a lubrication system for circulating motor oil to lubricate moving internal parts of the engine
an exhaust system through which exhaust passes from combustion chambers of the engine into surrounding atmosphere;
an aftertreatment device for treating exhaust passing through the exhaust system before the exhaust enters the atmosphere;
an engine control system for processing various data to control various aspects of engine operation including
a) occasionally causing forcing regeneration of the aftertreatment device to remove at least some material whose unchecked accumulation in the device would impair effectiveness of the device, and
b) processing data that identifies each occurrence of an active regeneration event that has occurred over a span of time during which the vehicle has been in use without any fresh motor oil being introduced into the engine, processing data that is indicative of degradation in lubricating quality of motor oil in the engine due to each identified occurrence of an active regeneration event to develop a data estimate of the amount of degradation due to each identified occurrence of an active regeneration event, and accumulating the individual data estimates to develop a data estimate of the amount of degradation that has occurred over the span of time during which the vehicle has been in use without any fresh motor oil being introduced into the engine.

14. A motor vehicle as set forth in claim 13 wherein the aftertreatment device comprises a diesel particulate filter that in the absence of a regeneration event traps particulates that are burned off during a subsequent regeneration event.

15. A motor vehicle as set forth in claim 13 wherein the control system comprises an algorithm for selecting one of different modes of forced regeneration based on operating condition of the vehicle.

16. A motor vehicle as set forth in claim 13 wherein the control system comprises an algorithm for processing the data estimate of the amount of degradation that has occurred over the span of time during which the vehicle has been in use without any fresh motor oil being introduced into the engine and a data value for a defined amount of degradation, and causing issuance of a distinctive signal when the processing of the data estimate of the amount of degradation that has occurred over the span of time during which the vehicle has been in use without any fresh motor oil being introduced into the engine and of the data value for a defined amount of degradation discloses that the amount of degradation that has occurred over the span of time during which the vehicle has been in use without any fresh motor oil being introduced into the engine exceeds the defined amount of degradation.
